(19) United States
(12) Patent Application Publication
(10) Pub. No.: US 2007/0216521 A1
(43) Pub. Date: Sep. 20, 2007

(54) Real-time traffic citation probability display system and method

(76) Inventors: Randall L. Guensler, Atlanta, GA (US); Jennifer H. Ogle, Clemson, SC (US)

Correspondence Address: Law Offices of Kenneth W. Float, 2095 Hwy 211 NW, #2F, Braselton, GA, 30517, US

(21) Appl. No.: 11/711,553

(22) Filed: Feb. 27, 2007

Related U.S. Application Data
(60) Provisional application No. 60/777,781, filed on Feb. 28, 2006.

(51) Int. Cl. B60Q 1/00; G08G 1/01

(52) U.S. Cl. 340/439; 340/936; 340/441

(57) ABSTRACT

Disclosed are systems and methods for assessing the relative probability that a driver will receive a traffic citation as a function of real-time, monitored vehicle activity within the context of historic spatial and temporal traffic citation data. Exemplary systems and methods determine risk as a function of such factors as (1) local roadway ticket histories, (2) vehicle characteristics, (3) real-time vehicle and engine operating parameters, (4) roadway and intersection design configurations, speed limit and design speed conflicts, and operating conditions, and (5) environmental conditions, for example.

### BACKGROUND

The present invention relates to traffic citation risk assessment, and more particularly to systems and methods designed to assess the probability of receiving a traffic citation as a function of where, when, and how a vehicle is driven, and to communicate that risk to the driver in real-time.

Most local and state law enforcement agencies develop and implement traffic enforcement policies associated with issuance of speeding tickets. For example, in the state of Georgia, local law enforcement agencies are prohibited from issuing traffic citations unless the vehicle is traveling 10 miles per hour over the speed limit, while the Georgia State Patrol is authorized to issue speeding tickets at any threshold over the speed limit. Even when written policies do not exist, enforcement policies associated with over-speed enforcement can be gleaned through the review of traffic citation histories. Statistical evaluation of the tickets issued by law enforcement officers provides insight into enforcement thresholds. Further analysis of ticket histories, evaluated over space and time, also provide insight into differences in enforcement policies throughout major urban areas. These citation history databases can be used to identify roadways upon which receipt of traffic citations is relatively higher than upon other roadways.

Because active systems designed to identify when law enforcement officers are tracking a vehicle's speed using radar or laser devices are illegal in many states, there is a need for passive systems and methods that provide real-time in-vehicle display of traffic citation risk as a function of real-time vehicle operations. The development of a passive advisory system that can alert the driver to the relative probability of receiving speeding tickets can provide a legal mechanism for alerting the driver of the relative benefits of controlling vehicle speed throughout the transportation network.

It would be desirable to have systems and methods that assess the probability of receiving a traffic citation as a function of where, when, and how a vehicle is driven, and to communicate that risk to the driver in real-time.

### BRIEF DESCRIPTION OF THE DRAWINGS

Various features and advantages of the present invention may be more readily understood with reference to the following detailed description taken in conjunction with the accompanying drawings, wherein like reference numerals designate like structural elements, and in which:

FIG. 1 illustrates communication elements involved in predicting real-time relative probability of receiving a traffic citation, including the flow of data elements to and from a vehicle;

FIG. 2 is a block diagram showing data systems involved in implementing the traffic citation risk communication system;

FIG. 3 illustrates a polygon system designed to represent a roadway network

FIG. 4 illustrates integration of historic traffic citation databases into a disaggregate analytical process employed in the systems and methods;

FIGS. 5a and 5b illustrate an exemplary traffic citation risk feedback system that operates in a vehicle; and

FIG. 6 illustrates an exemplary traffic citation risk communication method.

### DETAILED DESCRIPTION

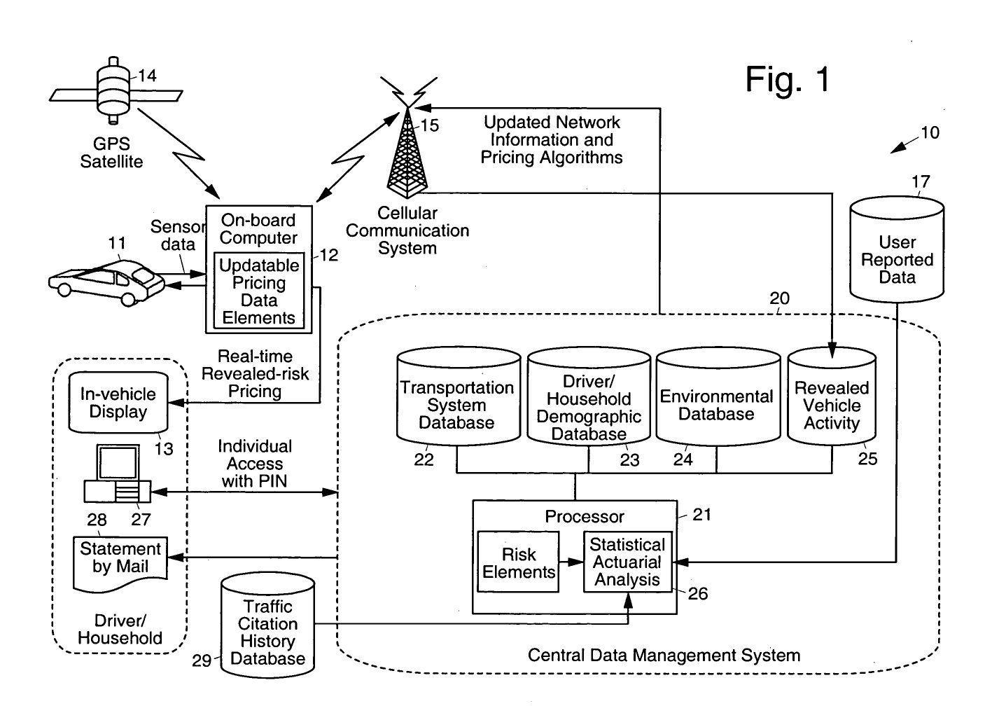

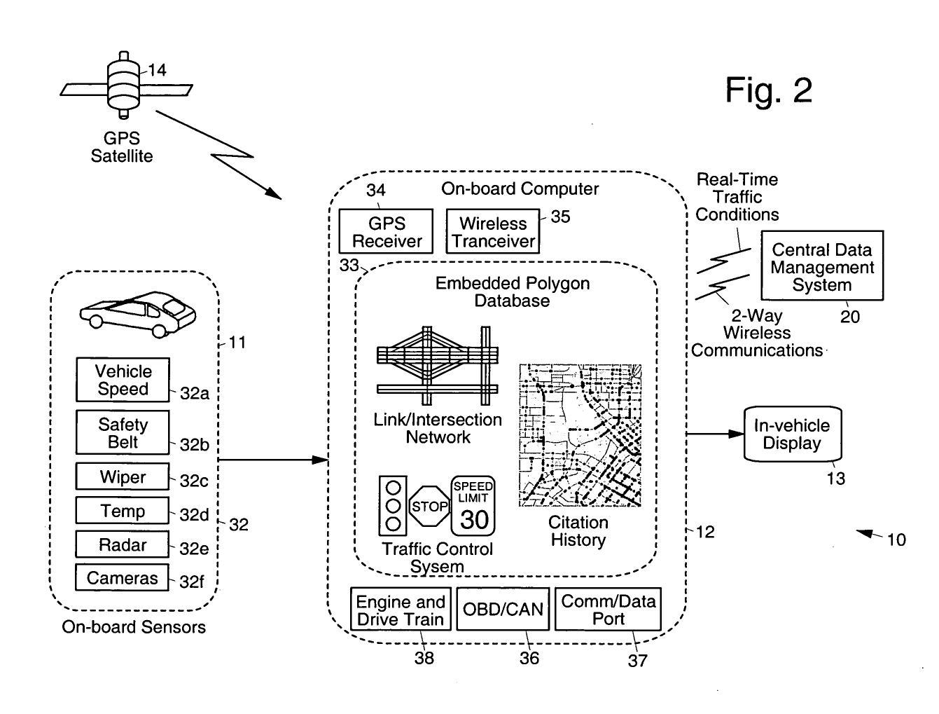

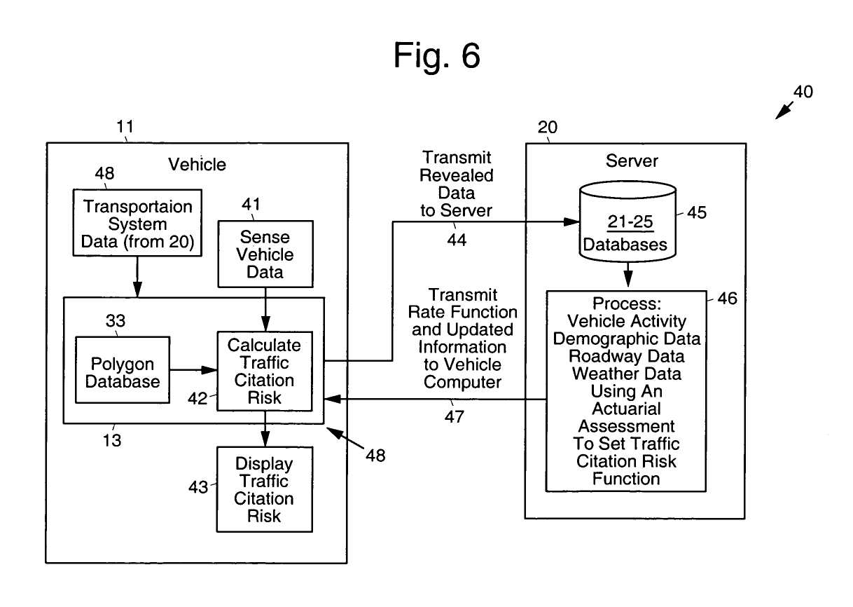

Disclosed are systems 10 (FIGS. 1 and 2) and methods 40 (FIG. 6) for assessing the probability of receiving a traffic citation as a function of real-time vehicle operations. Exemplary systems 10 and methods 40 determine relative probability as a function of such factors as (1) vehicle location and law enforcement jurisdiction, (2) vehicle characteristics, (3) real-time vehicle and engine operating parameters, (4) roadway and intersection design configurations and operating conditions, and (5) environmental conditions, for example. A vehicle computer system described in U.S. Provisional Patent Application No. 60/727,505 entitled “Real-Time, Revealed-Risk Insurance Pricing,” may be employed in the deployment of the disclosed risk-communication system. In the disclosed systems and methods, the probability of receiving a traffic citation is calculated as a function of the historic number of citations issued in the immediate vicinity of the vehicle divided by historic vehicle miles of travel on the facility, and modified by intersection and roadway design, vehicle characteristics, and vehicle operating conditions (e.g., speed vs. speed limit).

Referring to the drawing figures, FIG. 1 illustrates an exemplary real-time system for assessing relative probability of receiving a traffic citation 10. In particular, FIG. 1 illustrates communication elements involved in citation probability assessment, including the flow of data elements to and from a vehicle 11. FIG. 2 is a block diagram showing data systems involved in implementing the traffic citation probability assessment system 10.

The exemplary system 10 comprises an onboard in-vehicle computer 12 that is coupled to an in-vehicle display 13. The in-vehicle display 13 is used to display relevant information to the driver of the vehicle 13. The in-vehicle computer 12 interfaces to and monitors outputs of various sensors 32, including a vehicle speed sensor 32a and vehicle safety belts 32b (seatbelts 32b), windshield wipers 32c (rain sensor 32c), temperature sensor 32d, forward-looking radar 32e, and video cameras 32f, for example. The in-vehicle computer 12 interfaces to a global positioning system (GPS) receiver 34 which receives GPS signals from one or more GPS satellites 14, which allow determination of vehicle location. The in-vehicle computer 12 interfaces to a wireless transceiver 35, which allows communication with a central data management system 20. The in-vehicle computer 12 comprises an embedded polygon database 33 facilitates the linkage of various data elements relating to roadway design, traffic condition, and driving performance, for example. The in-vehicle computer 12 is coupled to an OBD/CAN interface 36 or other sensors for monitoring vehicle and engine parameters. The in-vehicle computer 12 has a communication port 37 which permits communication with a central server and remote data transmission and computing locations.

As is shown in FIG. 2, the central data management system 20 comprises a processor 21 that is coupled to multiple databases 22-25, 29. Exemplary databases 22-25, 29 include a traffic citation history database 29, a transportation system database 22, a driver/household demographic database 23, an environmental database 24, and a revealed vehicle activity database 25. The central data management system 24 interfaces to the World Wide Web, or Internet, to permit remote access. The traffic citation history database 29 is accessible by way of the World Wide Web, or Internet, for example, by the vehicle driver using a personal computer 27 or other web-enabled device, and entry of a personal PIN number, for example. The processor 21 is also used to generate billing statements 28 that are mailed to the driver of the vehicle 11.

The in-vehicle computer 12 comprises software algorithms that employ remotely-updatable polygon fields (comprising the embedded polygon database 33) that bound discrete transportation facilities, or employ GIS-based buffer methods or other means, to link roadway and intersection design configurations (i.e., roadway data) to real-time vehicle activity data. The GPS receiver 34 provides date, time, and vehicle location data. Vehicle performance characteristics or specifications may be derived from vehicle identification numbers (horsepower, body style, options, etc.).

The OBD/CAN interface 36 or other in-vehicle sensors networks, provide on road vehicle operating conditions, which are joined in real time with roadway data.

The systems 10 and methods 40 communicate estimated traffic citation risk by risk-element to the driver for the purposes of affecting changes in driver behavior. The systems 10 and methods 40 collect, transmit, consolidate, and evaluate vehicle and engine activity data within the context of local roadway traffic citation issuance data to continuously refine probability algorithms used to assess the relative risk of receiving a traffic citation.

Exemplary systems 10 and methods 40 may assess probability of receiving a traffic citation as a function of real-time, revealed driver risk, where risk is assessed as a function of where, when, how, and under what conditions a vehicle 11 is operated, and by whom. Revealed risk may be statistically-derived as a function of (1) driver, passenger, and household demographics, (2) vehicle characteristics, (3) real-time vehicle and engine operating parameters, (4) roadway and intersection design configurations and operating conditions, and (5) environmental conditions. Reduced-to-practice citation risk algorithms are developed using statistical analysis of data transmitted from vehicles 11 and drivers that participated in programs as discussed below.

The in-vehicle computer 12 and embedded software includes a CPU, data storage, the global positioning system (GPS) receiver 34, the OBD/CAN interface 36 to onboard diagnostics system or a direct connection to engine systems 38, a set of input/output lines to connect to external sensors 32, the communications port 37 (e.g., RS-232 or USB) for integrating optional environmental sensors, and a transponder 35 for transmitting and receiving data updates from remote systems (satellite, cellular, WAN, WiFi, WLAN, ad-hoc vehicle-to-vehicle, or other electronic means). The in-vehicle computer 12 may be installed as a separate unit in an aftermarket scenario, as in a reduced-to-practice embodiment, or may be integrated into the vehicle 11 by an original equipment manufacturer.

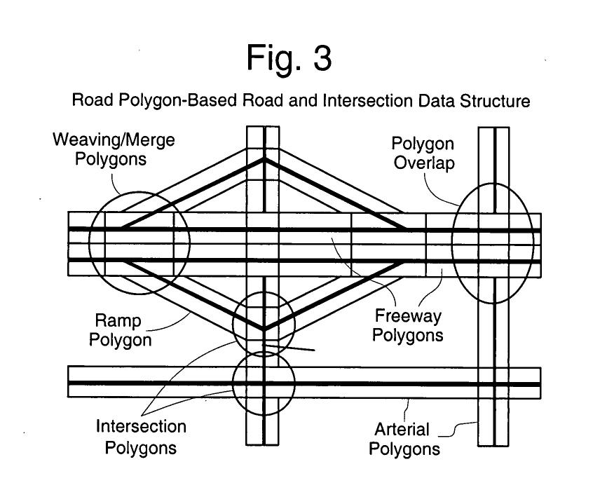

The in-vehicle computer 12 employs remotely-updatable polygon fields, or employ GIS-based buffer methods or other means, illustrated in FIG. 3 (where polygons are established such that they bound discrete transportation facility links) where the entire set of polygons represents the system of roads upon which the vehicle 11 operates (updatable as a function of vehicle position so that vehicle 11 can move seamlessly from city-to-city). FIG. 3 illustrates a polygon system designed to represent a roadway network. The transportation system in Atlanta, Georgia, for example, is currently represented by approximately 16,000 polygons. The GPS receiver 34 provides date, time, and vehicle location (latitude/longitude) allowing every second of vehicle operation to be allocated to a roadway link polygon (using a standard point-in-polygon position test for latitude and longitude) or to off-network activity.

Each polygon, or GIS-based buffer or other location element, is coupled with specific roadway and intersection design configuration and current operating condition (average speed, speed/acceleration distribution, acceleration noise, traffic density, etc.) data. Current aggregate operating conditions for any roadway (average vehicle speeds, traffic density, etc.) are transmitted on a polygon-by-polygon or buffer by buffer or location element basis as they are received from government-operated advanced traffic management systems, third-party providers, or through the transmission of data from a sufficient number of vehicles participating in the system. Typically, only changed state data are transmitted to reduce data transmission costs. The OBD/CAN interface 36 provides access to vehicle operating conditions that are joined in real-time with roadway data, so that vehicle performance relative to prevailing vehicle activity can be compared (speed differentials relative to other traffic are identified in this manner). The probability of receiving a traffic citation can be adjusted upwards or downwards as a function of the speed of the monitored vehicle relative to the speed of prevailing traffic.

Citation risk algorithms are developed through statistical analysis of the detailed traffic citation data and historic transportation network operating conditions transmitted by all vehicles 11 participating in a monitoring program (and other data collected in similar formats procured through research studies). The resulting algorithms are designed to identify the relative probability of receiving a traffic citation on a per-mile or per-hour basis. The system employs large traffic citation data sets (wherein citation records are reviewed and coded to specific roadway and intersection locations) to establish citation issuance patterns throughout the metropolitan area. A subscriber system 17 allows users to report the location of speed traps for incorporation into the citation risk database for use in adjusting historic citation risk. The citation risk is based upon revealed risk as defined through the analysis of large traffic citation databases.

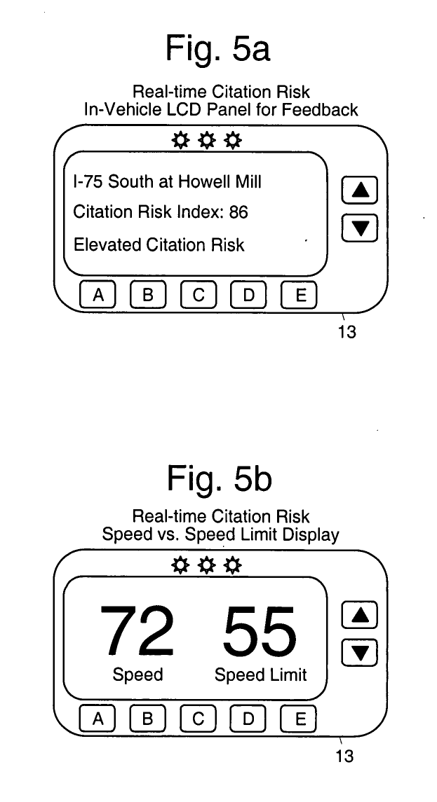

The system 10 also communicates estimated citation risk by risk element to the driver by way of the in-vehicle display 13 for the purposes of affecting changes in driver behavior (see FIGS. 5a and 5b). The system 10 thus provides the simultaneous benefits of informing the driver of his or her current citation risk, educating the driver about the relationship between monitored high-risk driver behavior (e.g., speeding, hard acceleration, rapid turn movements, etc.) and citation risk, and providing an influence designed to modify driver behavior and improve overall system safety and efficiency.

The citation risk algorithms are updated by the service provider on a regular basis as new cause-effect relationships and surrogate variables (such as current speed in excess of speed limit by road type, acceleration noise, stopline acceleration rate, mid-block rapid deceleration rate, etc.) are revealed through ongoing statistical analysis of historic citation databases and historic roadway operating conditions.

The system 10 provides the data and the data structure to allow for implementation of automated statistical analysis 26 of the comprehensive analytical database since the system 10 continuously appends new vehicle activity data. This allows analytical staff to continuously refine probability algorithms and to identify direct and surrogate variables for use in algorithm development.

By undertaking detailed actuarial analysis of all vehicles participating in the program (and other data collected in similar formats procured through research studies), providers can continuously refine relative citation risk calculations. Each second of vehicle operation monitored by the system is linked directly to driver and vehicle characteristics, roadway design parameters, actual on road operating conditions, temporal traffic citation histories for the roadway facilities traversed, and environmental conditions. By automating the process of basic statistical analysis 26 (descriptive statistics, cross-tab analysis, regression tree analysis, etc.) and by automating the process of creating data subsets for more advanced statistical techniques (such as logit and probit models) designed to assess the potential contributions of specific variables to the probability of receiving a citation.

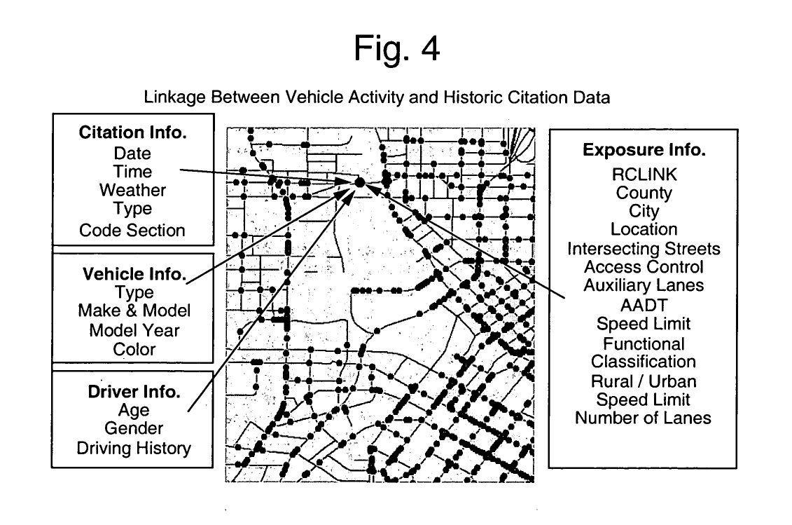

FIG. 4 illustrates integration of historic traffic citation databases into a disaggregate analytical process employed in the systems 10 and methods 40. By integrating individual citation histories to the network for statistical analysis 26 relative to prevailing operating conditions at the time of citation issuance, specific risk associated with operating on specific facilities can be derived. Certain vehicle makes, models, model years, and colors tend to be ticketed more often than others. Poorly-designed roadway systems that contribute to citation issuance (e.g. roadways with design speeds significantly higher than posted speed limits) are also identified through disaggregate analysis of these linkages.

The methods 40 and software for integrating, managing, updating, and storing infrastructure data, current vehicle position data, and real-time data streams within the in-vehicle computer monitoring data as needed to calculate citation risk algorithms. These citation algorithms involve the following:

(1) Vehicle characteristics, including such data as: vehicle class, vehicle make, model, and model year, color, vehicle options, engine configuration, horsepower, aggregate vehicle make and model traffic citation histories, for example;

(2) Real-time vehicle and engine operating parameters, and rate of change of operating parameters, including such data as: vehicle speed, acceleration, engine speed, throttle position, manifold pressure, engine load, percent of rated load, etc., commonly available from the OBD/CAN system or other vehicle sensor networks;

(3) Roadway and intersection design and operating parameters, including such data as: road class, lane width, shoulder width, speed limit, engineering design speed, school zone presence, construction zone presence, roadway curvature, sight distance, intersection configuration, signal timing plan, regional traffic citation history data disaggregated to roadway link and intersection in space and time, highway capacity manual parameters affecting roadway capacity, current average traffic speed and speed and acceleration distribution, for example; and

(4) Environmental conditions, including such data as: temperature, humidity, precipitation rate, light level, sun azimuth, for example.

The system 10 connects GPS-derived vehicle position to roadway and intersection design configuration data, which uses a remotely-updatable point-in-polygon, buffer, or location element system on the in-vehicle computer 12 in which the location fields (latitude/longitude coordinates or buffers bounding discrete transportation facilities) store encoded data for each transportation link and intersection, and through which each second of vehicle position is joined to applicable intersection design and operating parameters for use in real-time citation risk assessment.

The polygon or location element data stored onboard the vehicle 11 remain static until commanded to change by a communication event. Hence, the data associated with each roadway polygon need only be updated when roadway design parameters or on road operating conditions change significantly. Thus, the system 10 comprises a message structure that communicates only the new data that needs to be updated (polygon identifier, data element identifier, and data element value) to each polygon field. The system 10 thus reduces transmission message size and cost.

With respect to roadway design parameters, the infrastructure starts with a pre-coded polygon or location element data included in standard roadway characteristics databases (transportation system database 22), including such parameters as: road segment length, number of lanes, lane width, roadway curvature, grade, roadway design speed, 15^{th} and 85^{th} percentile speed, intersection channelization, weave and gore area parameters, signal timing plans, and signal timing progression, for example.

An Internet site may be provided so that official state department of transportation representatives (with proper login authority) can change the design parameters associated with specific roadways when roadway improvements are made. The Internet site may be used by transportation officials to designate new school and temporary construction zones (with reduced speed limits). A systems operator is responsible for reviewing and confirming all such changes. The operating characteristics associated with each polygon or location element (including current average operating speed and speed and acceleration distribution) are derived from either external data sources (e.g. government agencies that operate traffic management centers, cellular providers, or other third party data providers), or by the system itself when sufficient instrumented vehicle density is provided by participants in the citation risk assessment system. The system 10 provides for the update of polygon or location element data associated with these monitored on road operating conditions. As with roadway design data, the message structure communicates only the new operating condition data that need to be updated (polygon or location element identifier, data element identifier, and data element value) to each polygon or location element field. At a minimum, these data elements include the following:

(1) Methods that automatically update roadway and intersection design configuration data associated with each polygon or location element as a function of multiple measurements provided by large numbers of instrumented vehicles operating on the system;

(2) Methods that allow state and local transportation design and operations engineers to remotely update roadway polygon or location element fields to reflect structural changes in the roadway and intersection design configurations (such as lane widths, shoulder widths, presence of abutments, etc.) as freeway and arterial improvement projects are undertaken;

(3) Methods and algorithms for calculating miles of vehicle travel, which employs both corrected- and filtered-GPS speed data and vehicle-speed-sensor data; and

(4) Methods for managing and transmitting monitored disaggregate vehicle and engine data streams, wherein vehicle data are encrypted and stored onboard the vehicle and transmitted via satellite, cellular, WAN WiFi, WLAN, or other telecommunications services to a contractor responsible for ongoing development of the algorithms used in assessing the probability of receiving a traffic citation.

As is illustrated in FIGS. 5a and 5b, the in-vehicle display 13 provides feedback to the driver regarding vehicle and engine operating parameters that most affect citation risk, including such parameters as: speed vs. speed limit, acceleration rate, jerk, engine speed, throttle dither, etc. The display 13 allows user to scroll between menus (using scrolling controls located on the right side of the display 13) to see which factors contribute the most to the elevated citation rate. This simultaneously serves as a driver-training tool by identifying high-risk driver behavior and providing an incentive to modify driver behavior. A website with user login and password protection may be provided to provide another way for a driver to examine, post-hoc, those variables that are contributing most to their citation risk. A set of menus accessed by way of the selectable icons (A-E) at the bottom of the display 13 allow the driver to identify ways to reduce their citation risk by identifying modifiable driver behavior elements, or by selecting alternative trip destinations, routes, and travel times. An interactive trip-planning website, including: distance to destination vs. distance to alternative destinations, roadway and intersection design configurations, roadway operating characteristics, roadway crash and traffic citation histories, etc. Parents should find the in-vehicle and Internet feedback systems particularly useful in educating young drivers.

To the extent that future travel conditions are predictable (recurrent congestion in major urban areas is predictable and secondary crash events associated with recurring speed differentials can be modeled probabilistically), the system 10 includes a pre-trip planning function delivered via Internet and in-vehicle text/graphic text display 13 (only while the vehicle 11 is parked) allowing users to select a destination by time of day and identify the lowest citation risk path of travel. The system 10 employs an iterative process to examine alternative path routes starting with shortest distance and shortest time paths, and calculates total citation risk and total time of travel so that the user can select their user-optimized path. This feature is structured to that the algorithms can be integrated with OEM and aftermarket route guidance systems.

The systems 10 and methods 40 may be configured to provide automated daily, weekly, or monthly reports to the driver or fleet owner via the Internet, including materials describing driver strategies designed to reduce citation risk.

The systems 10 and methods 40 collect, transmit, consolidate, and manage individual vehicle and engine activity data and to automatically couple historic driver/vehicle operating data, historic roadway operating condition data, and citation-related data.

The systems 10 and methods 40 provide for automated statistical analysis 26 of the comprehensive analytical database as new vehicle data are added, so as to continuously refine citation risk algorithms, and to identify direct and surrogate variables for use in citation risk algorithm development.

FIG. 6 illustrates an exemplary method 40 for generating traffic citation risk estimates in real time. As is shown in FIG. 6, vehicle data such as vehicle speed, vehicle operating conditions, and environmental conditions, for example, are sensed 41 and input to the in-vehicle computer 12. The sensed data and data from the polygon or location element database 33 and transportation system operating condition data transmitted to the vehicle via the central server are processed using predetermined algorithms in the in-vehicle computer 12 to calculate 42 traffic citation risk in real time. The calculated citation risk, (along with other selected data) is displayed 43 to the driver of the vehicle 11. The sensed data is transmitted 44 to the central server 20 and is stored 45 in the revealed vehicle activity database 25. The stored revealed vehicle activity data along with data contained in the other databases 22-24, 29 are processed 46 using actuarial assessment to determine the current citation risk function. The computed citation risk function is transmitted 47 to the in-vehicle computer 12 and stored 48.

In order to implement the exemplary method 40, vehicle systems, remote server systems and Internet systems are integrated together as described below.

Vehicle Systems

The in-vehicle computer 12 receives and processes input data from onboard vehicle systems (global positioning system 34, component sensors 32b-d, engine computers, forward looking radar 32e, machine vision, and video cameras 32f, etc., from roadside communications (intelligent traffic signals, fog warning devices, etc.), from the central server (real-time prevailing traffic speeds, variable speed limits, environmental conditions, etc.) and from vehicle-to-vehicle communications (proximity, speed differential, etc.). The software that runs on the in-vehicle computer 12 identifies the current location of the vehicle 11 on the roadway system and the current state of vehicle operations, using these and any other available input data. The onboard computer 12 processes the available input data to derive a comprehensive set of variables that are then used to calculate real-time risk of receiving a traffic citation.

Software in the vehicle computer 12 uses the current vehicle position to identify the physical location of the vehicle 11 in real time. Geographically-coded points, links, and polygons (latitude/longitude coordinates bounding discrete transportation facilities), or GIS-based buffers, or other location elements, represent the transportation system on the vehicle computer 12. Each transportation system element is then associated through a database with remotely-updatable data for that applicable roadway link or intersection location so that the roadway design and operating parameters can be used to determine real-time traffic citation risk. For example, real-time prevailing vehicle speeds are currently available for freeway operations in many urban areas from the regional traffic operations center. Prevailing speeds may be derived from instrumented vehicles operating on each facility, where speeds are communicated from vehicle to vehicle.

The server software automatically updates roadway design parameters (such as number of lanes or speed limit) whenever design changes are made to the transportation system. The server software automatically updates roadway operating characteristics associated with each point, link, and polygon or location element in the transportation system (including current average operating speed, and speed/acceleration distribution) when such data are available. In practice, only significant changes in the system operating characteristics are transmitted from the server 20 to the vehicle computer 12 and integrated with transportation system points, lines, and polygons database 33. Data transmission can be by any local means, including but not limited to satellite, cellular, WAN, WiFi, WLAN, vehicle-to-vehicle, or other telecommunications services.

The software mechanisms described above provide a comprehensive system allowing each second of vehicle operation to the real-time design and operating characteristics for the facility that is traveled.

A set of updatable equations are pre-programmed in the in-vehicle computer 12 to calculate real-time citation risk as a function of the processed input parameter values. The complexity of the equations varies from application to application. Depending upon the application, the risk-based equations can range from simple (for example, a series of multi-dimensional lookup tables), to complex (for example, calculations using a choice-based probability equation). The pre-programmed equations can be changed at any time by the remote server 20, where the updated equations reflect the most recent results of statistical analysis of large databases. Hence, the onboard computational scheme changes in response to changes in risk over time.

The calculated citation risk is displayed in real-time on the in-vehicle display 13. The display 13 provides visual feedback (or optional auditory feedback) to the driver indicating the relative probability of receiving a citation, given real-time vehicle operating conditions, current roadway operating conditions, and historic citation data. The feedback includes those primary vehicle and engine operating parameters that most affect real-time citation risk. Feedback is delivered via the in-vehicle display 13, website, or email/mail notification including such parameters as: speed versus speed limit, acceleration rate, jerk, engine speed, throttle dither, tailgating, steering correction, etc. Warning lights may be illuminated on the display 13 (or sound, or other sensory feedback may be provided) to alert the driver that one or more vehicle operating parameters that are within their control (for example, speed versus speed limit) are causing an elevation in risk and therefore probability of receiving a citation.

The data collected by the in-vehicle computer 12 during the course of each trip are retained for transmission to the remote server 20. These data, collected in real-time by the in-vehicle computer 12 during each vehicle trip, are migrated to the revealed vehicle database 25 on the remote server for use in enhanced actuarial analyses. Data can be collected at high resolution (more than once per second) or low resolution, depending upon the relevance of the parameter in actuarial analysis. As with inbound data, outbound data transmission can be by any local means, including but not limited to satellite, cellular, WAN, WiFi, WLAN, vehicle-to-vehicle, or other telecommunications services.

Remote Server Systems

The remote server 20 maintains a master data set for the transportation system. Updates to transportation system information (design and operations) are managed by the server 20 and updated data elements are transmitted to in-vehicle computer 12 whenever they are updated. Similarly, the server 20 manages operating system conditions data provide by third parties (e.g. a government traffic operations center or contracted third party) or from the instrumented vehicles themselves as they periodically upload their travel data. Updates to travel conditions such as prevailing vehicle speeds, pavement conditions, environmental conditions, etc., are sent at pre-determined intervals, changing the citation risk calculated by the in-vehicle computer 12.

The assessment of citation risk as a function of real-time operating parameters can be enhanced by the development of a large dataset containing detailed information about traffic citation issuance and real-time driving conditions at the time citations are issued. Citation history data provide the dependent variables for use in risk assessment, wherein the model will be used to predict probability of receiving a citation in time and space as a function of citation type and citation event variables. The dependent variables affecting the probability of receiving a citation at first derived from analysis of citation databases. However, over the long term, the information needed for assessing risk and damage will come from the instrumented vehicle fleet itself as prevailing on road traffic conditions are monitored by the server system 20.

The independent variables used in the analyses of citation probability are included in the four main analytical databases: transportation system database 22, driver/household demographic database, 23 environmental condition database 24, and the revealed vehicle activity database 25 which contains all vehicle activity data uploaded by participating vehicles 11). Traffic citation probability is predicted as a function of these independent variables.

The automation of actuarial analysis (using statistical actuarial analysis 26) facilitates the ongoing reassessment of risk as a function of driver behavior, roadway design, and environmental conditions. The software may employ traffic citation history databases 29 to provide estimates of total traffic citations by region, by citation type. Analytical software then assesses probability of traffic citation issuance per mile as a function of: driver and household demographic parameters, individual driver ticket histories, and vehicle characteristics, as well as the characteristics of the actual roadway systems traveled, including roadway system design, roadway operating conditions, and roadway environmental conditions. The parameters employed in the risk assessment include only those parameters for which data will be available on the in-vehicle computer 12 or can be derived from other input data. The statistical analysis yields a series of equations that are uploaded to the in-vehicle computer 12 for use in real-time citation risk assessment, where risk is a function of where, when, how, and under what conditions the vehicle is driven. These equations are uploaded by the server to the vehicles and updated whenever changes to the premium structure are implemented.

Internet Systems

A pre-trip planning function delivered via Internet and in-vehicle text/graphic text display 13 allows users to select a destination by trip purpose and identify the path of travel with the lowest citation risk. The pre-trip planning system allows drivers to respond to travel parameters that are out of their control that may significantly elevate their citation risk, for example intersection or roadway design parameters where design speed is significantly higher than established speed limit, real-time traffic flow conditions, and ticket histories that may indicate previous presence of speed traps. To facilitate the planning function, the software that runs on the in-vehicle computer 12 includes shortest path network algorithms coded with time penalties are coupled with the design and operations data available from the server 20 to calculate total travel risk and identify the individual parameters, rank-ordered by risk, that most significantly affect citation risk by each route.

By examining the series of paths between a large number of origins and destinations, the software system identifies the intersections and roadways that yield the highest citation risk due to their current design and operating conditions (for example, many roads are designed for operating speeds that are significantly higher than the posted speed limits). This software may be used by analysts to prepare automated reports for transportation agencies that rank order the benefits available from improving problem intersections and corridors in their region.

Thus, systems and methods that operate in real time to alert drivers of their risk of receiving traffic citations have been disclosed. It is to be understood that the above-described embodiments are merely illustrative of some of the many specific embodiments that represent applications of the principles discussed above. Clearly, numerous and other arrangements can be readily devised by those skilled in the art without departing from the scope of the invention.

What is claimed is:

1. A real-time traffic citation risk assessment system comprising:
an in-vehicle computer coupled to vehicle sensors that sense vehicle position, speed, and operating parameters;
an in-vehicle database comprising vehicle characteristics, vehicle performance characteristics, driver and household demographics, roadway characteristics and roadway operating conditions, environmental conditions, and roadway links that link vehicle position;
software that runs on the in-vehicle computer that determines the relative risk of receiving a traffic citation using predetermined risk functions in real time derived from data in the database and the vehicle sensors; and
an in-vehicle display for displaying the computed relative risk of receiving a traffic citation to the driver of the vehicle in real time.

2. The system recited in claim 1 wherein the in-vehicle computer is capable of communicating with a remote server that comprises:
a transportation system database that comprises roadway characteristics and roadway operating conditions;
a demographic database comprising driver and household demographics;
a revealed vehicle activity database that comprises vehicle activity data;
an environmental database comprising environmental data;
a database comprising the histories of citations issued in space and time;
statistical actuarial analysis database comprising risk of citation issuance;
which databases are linked with respect to their characteristics; and
a processor for computing updated citation risk as a function of the data in the respective databases and for updating the risk function in the software that runs on the in-vehicle computer.

3. The system recited in claim 2 wherein the roadway design and operating parameters and driver and household demographics are remotely updatable from the remote server.

4. The system recited in claim 1 wherein the display presents real-time feedback to the driver relating to vehicle and engine operating parameters that affect risk of receiving a traffic citation.

5. The system recited in claim 2 wherein the remote server is in communication with a driver/household computer to permits review previous trips and planned future trips to minimize risk of receiving citations related to the future trips.

6. The system recited in claim 2 wherein the remote server is in communication with a driver/household computer to permits identification of the lowest risk path of travel.

7. The system recited in claim 2 wherein the processor on the remote server is configured to automate data processing and management and automate statistical analysis in response to changes in received data.

8. The system recited in claim 2 wherein the processor on the remote server is configured to create reports identifying the effect of roadway/intersection design and operating parameters on risk of receiving traffic citations, for use in improving roadway characteristics and roadway operating conditions.

9. The system recited in claim 1 wherein the roadway links comprise updatable point-in-polygons in which polygon fields, comprising latitude/longitude coordinates bounding discrete transportation facilities, store encoded data for each transportation link and intersection.

10. The system recited in claim 1 wherein the roadway links comprise updatable location elements that store encoded data for each transportation link and intersection that are linked to vehicle position.

11. A real-time citation risk evaluation method for use in a vehicle, comprising:
storing, in the vehicle, vehicle characteristics and vehicle performance characteristics, driver and household demographics, roadway characteristics and roadway operating conditions, environmental conditions, and roadway links that link vehicle position;
sensing, in the vehicle, vehicle position, speed, and operating parameters;
receiving, in the vehicle, prevailing roadway speeds and environmental conditions;
computing, in the vehicle, using predetermined citation risk functions, derived from the sensed vehicle speed and position, received roadway speeds and environmental conditions, and the stored data; and
displaying the computed citation risk to the driver of the vehicle in real time.

12. The method recited in claim 11 further comprising:
communicating with a remote server;
accessing roadway characteristics and roadway operating conditions, driver and household demographics, vehicle activity data, environmental data, spatially resolved traffic citation history data, all of which are linked with respect to their characteristics;
computing updated probability of receiving a traffic citation as a function of the accessed data; and
updating the risk functions on the in-vehicle computer for use in computing the probability of receiving a traffic citation.

13. The method recited in claim 12 further comprising remotely updating the roadway design and operating parameters and speed enforcement policies for the applicable geographic area from the remote server

14. The method recited in claim 11 wherein displaying real-time feedback to the driver relating to vehicle and engine operating parameters that affect probability of receiving a traffic citation.

15. The method recited in claim 12 further comprising communicating between the remote server to a driver/household computer to permit review previous trips and planned future trips to minimize citation risk related to the future trips.

16. The method recited in claim 12 further comprising communicating between the remote server to a driver/household computer to permit identification of the lowest citation risk path of travel.

17. The method recited in claim 12 further comprising automating data processing, management, and statistical analysis in the remote server in response to changes in received data.

18. The method recited in claim 12 further comprising creating reports on the remote server to identifying the effect of roadway/intersection design and operating parameters on risk of receiving traffic citations, for use in improving roadway design parameters and roadway operating conditions.

19. The method recited in claim 11 wherein the roadway links comprise updatable point-in-polygons in which polygon fields, comprising latitude/longitude coordinates bounding discrete transportation facilities, store encoded data for each transportation link and intersection.

20. The method recited in claim 11 wherein the roadway links comprise updatable location elements that store encoded data for each transportation link and intersection that are linked to vehicle position.
